(19) United States
(12) Patent Application Publication
(10) Pub. No.: US 2004/0164683 A1
(43) Pub. Date: Aug. 26, 2004

(54) Waterproof and fire retardant modular electro-luminescent lamp strip kit

(76) Inventor: Brian K. Bettis, Laguna Beach, CA (US)

Correspondence Address: WELSH & KATZ, LTD, 120 S RIVERSIDE PLAZA, 22ND FLOOR, CHICAGO, IL, 60606, US

(21) Appl. No.: 10/427,268

(22) Filed: May 1, 2003

Related U.S. Application Data
(63) Continuation of application No. 10/373,417, filed on Feb. 24, 2003, now abandoned.

(51) Int. Cl. G09G 3/10

(52) U.S. Cl. 315/169.3

(57) ABSTRACT

The modular kit of components for an electro-luminescent lamp assembly comprises: at least one elongate electro-luminescent (EL) lamp strip having a front side which can emit electro-luminescent light and a back side having fixing means thereon for fixing the EL lamp strip to a surface; an inverter and power supply unit including an inverter circuit and a battery power source; the inverter and power supply unit having a switch including at least an ON position and an OFF position; and, coupling structure for coupling the EL lamp strip to the inverter and power supply unit after the EL lamp strip is mounted on an object.

### CROSS-REFERENCE TO RELATED APPLICATIONS

This application is a continuation of U.S. application Ser. No.10/373,417, filed Feb. 24, 2003, for WATERPROOF AND FIRE RESISTANT MODULAR ELECTRO-LUMINESCENT LAMP KIT.

### BACKGROUND OF THE INVENTION

1. Field of the Invention

The present invention relates to a modular system for creating electro-luminescent lamp strip assemblies for use on objects such as on safety vests, life jackets, fireman, policeman and construction worker's jackets, helmets and backpacks.

2. Description of the Prior Art.

Heretofore a number of different systems have been proposed for placing electro-luminescent lamp strips on various objects. Examples of analogous and non-analogous electro-luminescent lamp strip assemblies on various objects are disclosed in the following analogous and non-analogous U.S. patents.

| U.S. Pat. No. | Patentee |
|---|---|
| 5,034,847 | Brain |
| 5,515,247 | Cheung et al. |
| 5,570,945 | Chien, et al. |
| 5,632,235 | Larsen, et al. |
| 5,667,394 | Chien |
| 5,688,038 | Chien |
| 5,740,705 | Chien |
| 5,746,501 | Chien |
| 5,775,016 | Chien |
| 5,836,671 | Chien |
| 5,921,563 | Chien |
| 5,876,108 | Chien |
| 5,980,060 | Chien |
| 6,075,322 | Pauly |
| 6,082,867 | Chien |
| 6,086,213 | Holce |
| 6,179,431 | Chien |
| 6,213,616 | Chien |
| 6,302,554 | Holce |
| 6,350,129 | Gorlick |

Published U.S. Patent Applications

| Publication No. | Applicant |
|---|---|
| 2001/0004808 | Hurwitz |

### BRIEF SUMMARY OF THE INVENTION

According to the present invention there is provided a modular kit of components for an electro-luminescent lamp assembly comprising: at least one elongate electro-luminescent (EL) lamp strip having a front side which can emit electro-luminescent light and a back side having fixing material thereon for fixing the EL lamp strip to a surface; an inverter and power supply unit including an inverter circuit and a battery power source; the inverter and power supply unit having a switch including at least an ON position and an OFF position; and, coupling structure for coupling the EL lamp strip to the inverter and power supply unit after the EL lamp strip is mounted on an object.

In one preferred embodiment, the power unit, the EL lamp strip or strips and the coupling are waterproof and/or coated with a fire retardant material, preferably a clear fire retardant material.

Also in one preferred embodiment the power unit and the strip or strips have an adhesive on a backside thereof and a cover sheet on the adhesive to facilitate shipping.

Additionally, a three-section strip can be provided to present three different colors.

Further, the power unit can contain a personal identification device, which can emit a signal to a satellite for being monitored by a geographical positioning system (GPS).

Still further, according to the present invention there are provided combinations of various kits with various objects, such as vests, life jackets, backpacks, helmets, containers, etc.

Finally, the vest can be provide with pull away straps connectable with hook and loop connectors between front and back panels of the vest and the strip assembly can be provided with easily separable plug and sockets in the over the shoulder wiring between front and back panels of the vest for safety purposes.

### BRIEF DESCRIPTION OF THE SEVERAL VIEW OF THE DRAWINGS

FIG. 1 is a front elevational view of a safety vest having mounted thereon electro-luminescent lamp strips of the kit of the present invention;

FIG. 1A is a fragmentary back view of the upper portion of the vest shown in FIG. 1;

FIG. 2 is a plan view of an elongate electro-luminescent lamp strip;

FIG. 3 is a plan view with portions shown in phantom of an end terminator which connects to one end of the electro-luminescent lamp strip shown in FIG. 2;

FIG. 4 is a plan view with portions shown in phantom of a straight connector between two electro-luminescent lamp strips;

FIG. 5 is a plan view of a corner connector with portions shown in phantom and connected to transverse ends of two electro-luminescent lamp strips;

FIG. 6 is a plan view of a short electro-luminescent lamp strip;

FIG. 7 is a plan view of a C-shaped electro-luminescent lamp strip;

FIG. 8 is a back view of a backpack having an electro-luminescent lamp strip mounted thereon;

FIG. 9 is a side view of the backpack shown in FIG. 8;

FIG. 10 is a front view of the backpack shown in FIG. 8;

FIG. 11 is a plan view of one embodiment of an inverter and power supply unit;

FIG. 12 is an exploded view of the layers forming one embodiment of each of the electro-luminescent lamp strips shown in FIGS. 2, 6, and 7 with the top and bottom layers being made of material which is water resistant and/or fire resistant;

FIG. 13 is an exploded view of a waterproof inverter and power supply unit;

FIG. 13A is an assembled view of the inverter and power supply unit shown in FIG. 13;

FIG. 14A is a front elevational view of a life jacket having electro-luminescent lamp light strips of the present invention mounted thereon;

FIG. 14B is a back view of the life jacket shown in FIG. 14A and shows electro-luminescent lamp light strips mounted thereon;

FIG. 14C is a front elevational view of the life jacket shown in FIG. 14A but with one side of the jacket opened;

FIG. 15A is a front elevational view of a safety vest having electro-luminescent lamp strips of the present invention mounted thereon;

FIG. 15B is a back view of the safety vest shown in FIG. 15A and shows electro-luminescent lamp strips mounted thereon; and

FIG. 15C is a front elevational view of the safety vest shown in FIG. 15A but with one side of the vest opened.

FIG. 16 is a plan view of a two strip kit comprising two electro-luminescent lamp strips each having a built in end terminator at one end and a connector at the other end and with adhesive on one side initially covered by a cover sheet, two wire cables and an inverter and power supply unit, shown connected together.

FIG. 17 is a front view of a helmet having the two electro-luminescent lamp strips shown in FIG. 16 adhesively fixed thereon and connected to a wire cable assembly which is connected to a inverter and power supply unit.

FIG. 18A is a side view of the inverter and power supply unit and is taken along line 18A-18A of FIG. 17.

FIG. 18B is a bottom view of the inverter and power supply unit and is taken along line 18B-18B of FIG. 18A.

FIG. 19 is a plan view of the wire cable assembly including a section of electro-luminescent wire.

FIG. 20 is a perspective view of a one-strip kit including a waterproof coupling and with an adhesive on the backside of a power unit and on the backside of the strip, the adhesive being covered with a cover sheet.

FIG. 21 is an exploded sectional view of the waterproof coupling.

FIG. 22 is a plan view of a composite U-shaped strip assembly, a waterproof inverter and power supply unit and a waterproof coupling.

FIG. 22A is a plan view of a three-section U-shaped strip assembly, which can be used in the assembly shown in FIG. 22.

FIG. 23 is an exploded view of the waterproof power unit shown in FIG. 22.

FIG. 24 is a plan view of the circuit board and battery compartment that is mounted in the waterproof inverter and power supply unit shown in FIGS. 22 and 23.

FIG. 25 is a plan view of a plug and socket, not connected, in a wiring assembly that extends over the shoulder in a vest having separable front and back panels.

FIG. 26 is a plan view of a strap assembly between the sides or over the shoulders in a vest assembly having separable front and back panels.

### DETAILED DESCRIPTION OF THE INVENTION

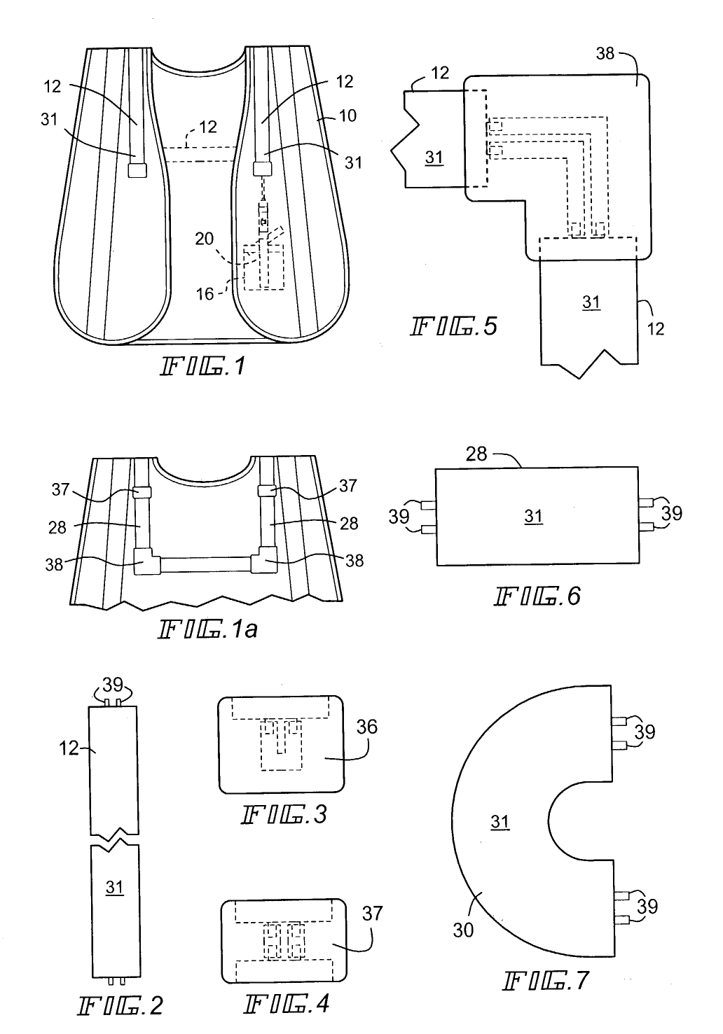

Referring now to the drawings in greater detail there is illustrated FIG. 1 one embodiment of a safety vest 10 which has electro-luminescent lamp strips (EL strips) 12 of the present invention mounted thereon. The vest 10 also includes a pocket 16 for receiving an inverter and power supply unit 20. The EL lamp strips 12 are preferably water resistant and can be both water resistant and fire resistant, as will be described in detail hereinafter in connection with the description of FIG. 12.

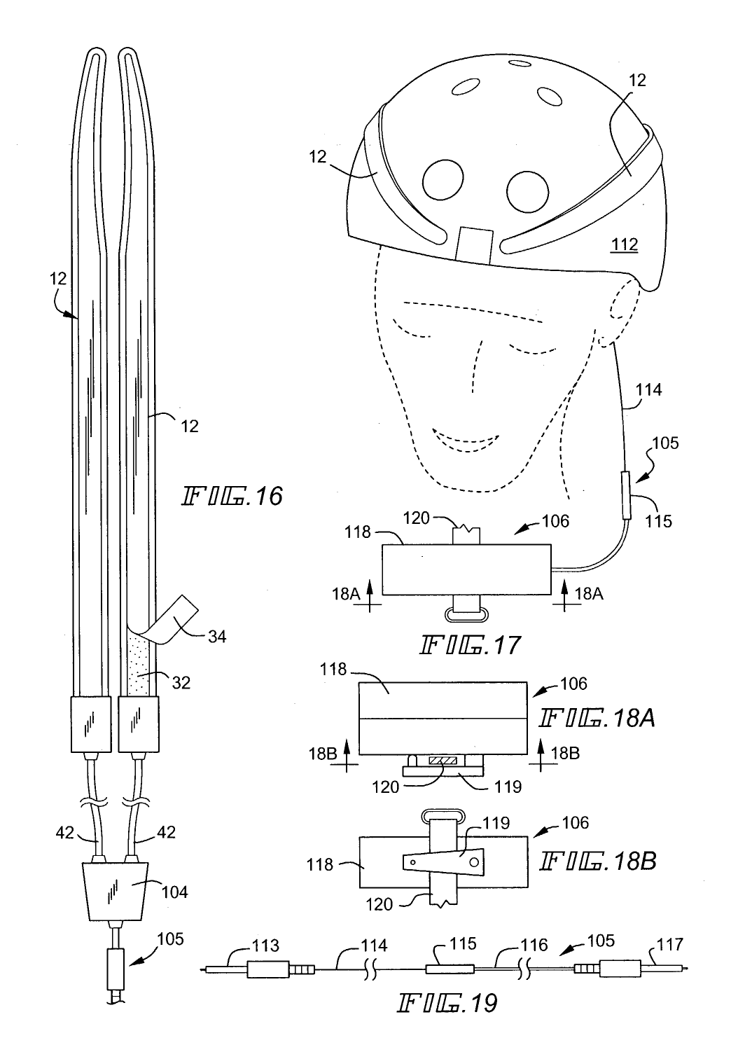

As shown in FIGS. 1 and 1A, the inverter and power supply 20 is shown as an elongated inverter and power supply 20 of the type illustrated in FIGS. 13 and 13A.

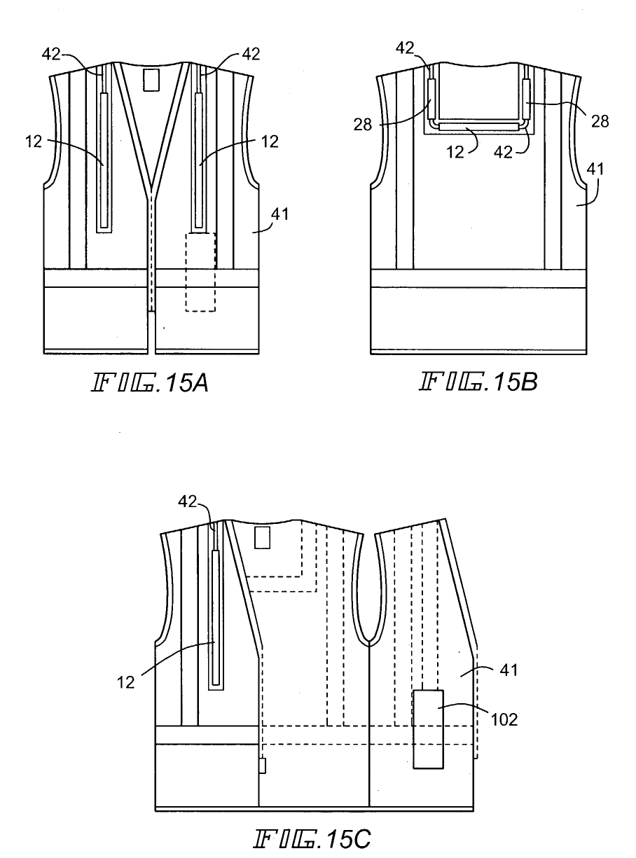

Alternatively, the inverter and power supply unit can be a boxed shaped unit 22, as shown in FIG. 11. The inverter and power supply unit 20 or 22 includes an inverter circuit and a battery power source, well known in the art (See, for example, the battery pack inverters sold by Electroluminescent Industries, Ltd. of Jerusalem, Israel), typically comprising two or more double “A” (AA) batteries or triple “A” ((AAA) batteries. If desired rechargeable batteries or a rechargeable battery unit can be provided. The inverter and power supply unit 20 and 22 each have a three position switch 24 (FIG. 13) or 26 (FIG. 11) including an ON position, an OFF position, and an intermittent or blink position. The unit 20 (FIG. 13A) or 22 (FIG. 11) also can have a duty cycle switch for adjusting the duty cycle of the intermittent or blinking light.

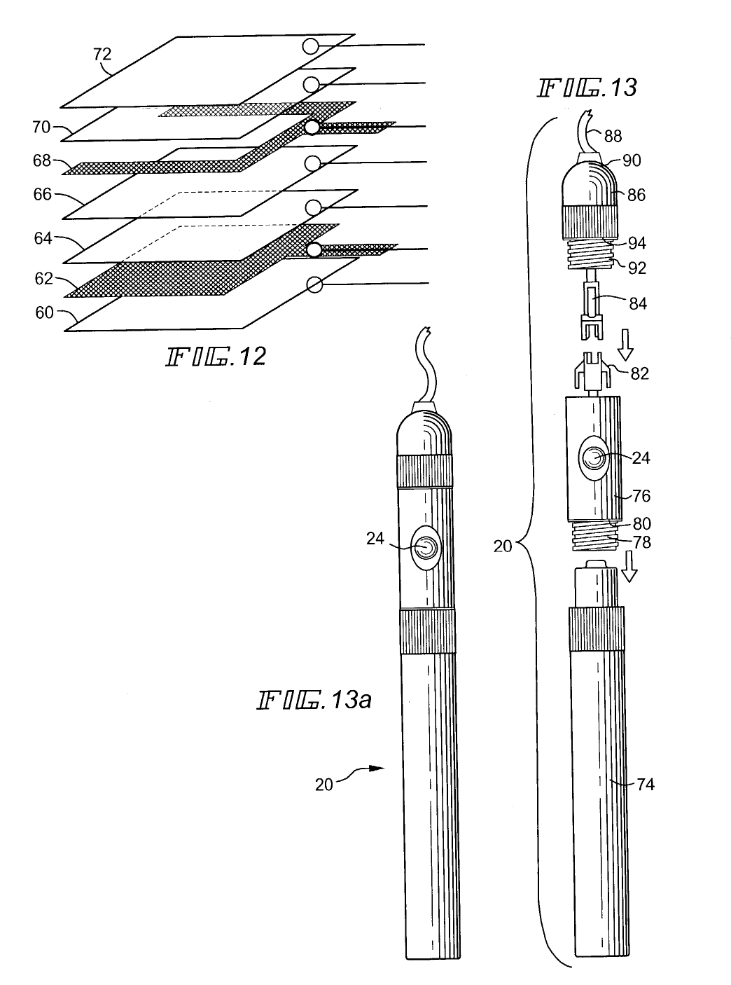

A long EL lamp strip 12 is shown in FIG. 2. A shorter EL lamp strip 28 is shown in FIG. 6 and a C-shaped EL lamp strip 30 is shown in FIG. 7. Each EL lamp strip 12, 28 and 30 has a top, light emitting side 31 and a bottom side and according to the teachings of the present invention, the bottom side has fixing material thereon such as an adhesive 32 (FIG. 16) or hook and loop material sold under the trademark VELCRO. When adhesive is used, a cover sheet 34 (FIG. 16) is initially placed on the adhesive until the EL lamp strip 12, 28 or 30 is ready for mounting. Also, while three EL lamp strip configurations 12, 28 or 30 are illustrated for creating words and symbols, additional strip configurations can be provided for creating more words or symbols. Each of these EL lamp strips 12, 28 or 30 is designed to be connected to an end terminator 36, or an inline connector 37 or to a corner connector 38. As shown, each EL lamp strip 12, 28 and 30 has end terminals 39 (FIGS. 2, 6 and 7).

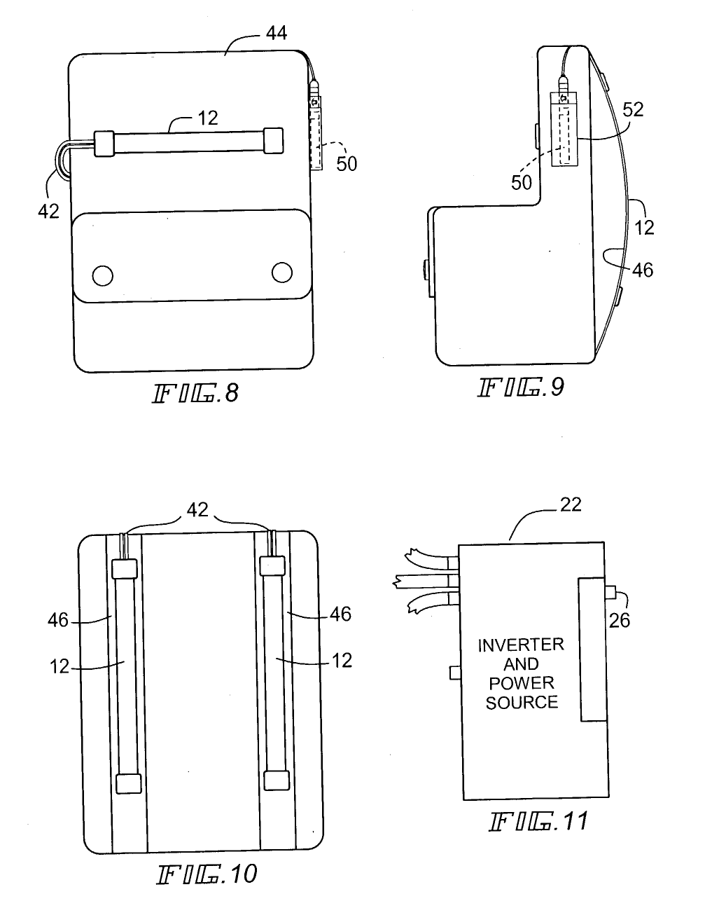

In FIG. 3 is shown an end terminator 36. Then an inline connector 37 is shown in FIG. 4 and a corner connector 38 is shown in FIG. 5. It is to be understood that the inline connector 37 can be significantly longer than the connector 37 shown in FIG. 4 and can be made of flexible materials. Likewise, the corner connectors 38 can have longer legs than shown in FIG. 5 and also can be made of flexible materials.

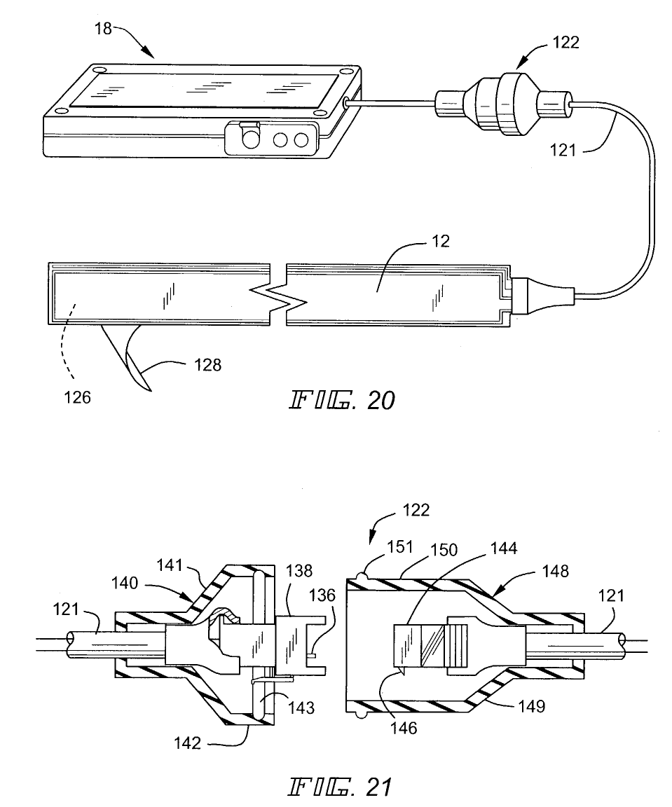

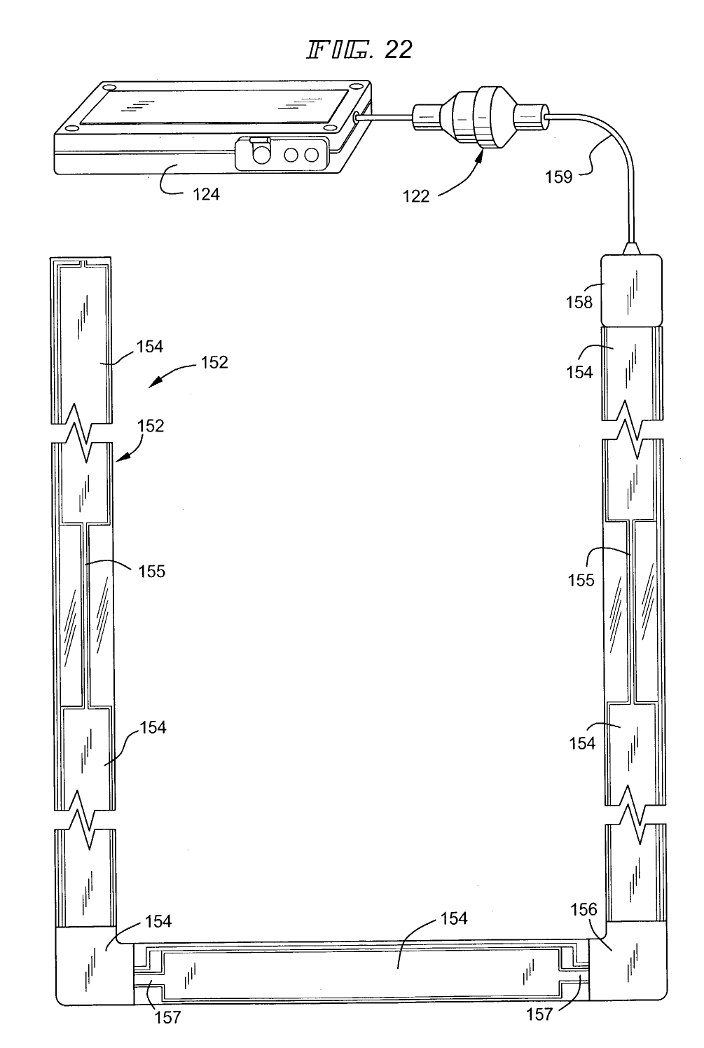

According to the teachings of the present invention, various modular EL lamp strip kits can be assembled and sold for different uses. For example a safety vest EL lamp strip kit can include three long EL lamp strips 12, two short EL lamp strips 28, two connectors 37, one end terminator 36, and two corner connectors 38 together with one inverter and power supply unit 20 or 22 for being mounted to a safety vest, such as the vest 10 shown in FIG. 1 or the vest 40 shown in FIGS. 14A-14C, or the life jacket 41 shown in FIGS. 15A-15C. Further, as will be described in connection with the description of FIGS. 25 and 26, the front and back panels of the vest and the over the shoulder wiring assembly between the front and back panels can be easily separated for safety purposes.

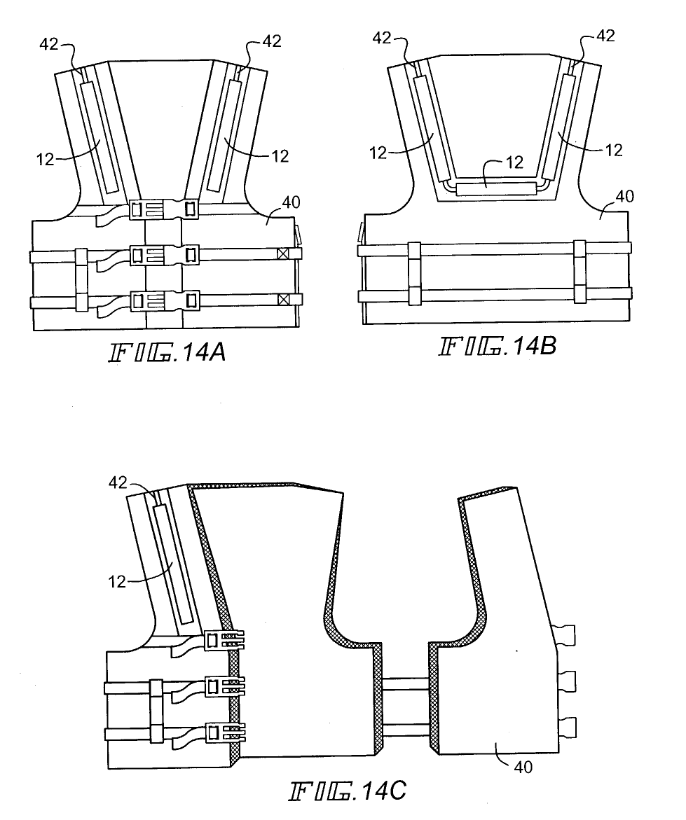

Also wire cables 42 (FIGS. 8,10 and 14A-15C) of different lengths in a wiring assembly can be included in the kit for connecting EL lamp strips 12, 28 or 30 which are spaced from each other and from the inverter and power supply unit 20 or 22 on the object (vest, jacket, helmet, backpack etc.) on which they are intended to be mounted.

Such an EL lamp strip kit containing three or four elongate EL lamp strips 12 is desirable for mounting on a backpack 44 as shown in FIGS. 8-10 where one EL lamp strip 12 is mounted in a generally horizontal position (FIG. 8) on the back of the backpack 44 and two EL lamp strips 12 are mounted in generally vertical positions, respectively, on shoulder straps 46 for the backpack 44 as shown in FIG. 10. Wire cables 42 connect the three EL lamp strips 12 to an inverter and power supply unit 50 which can be identical to the unit 20 and which can be mounted in a pocket 52 on a side of the backpack 44.

Referring now to FIG. 12 in greater detail, an exploded laminated EL lamp strip 12 is illustrated in FIG. 12. The strip 12 is shown as having a bottom urethane sheet 60, and above that is a rear electrode 62, which is preferably made of copper. Above the rear electrode 62 is an insulated sheet 64, preferably made of a plastic material.

Then, above the insulator sheet 64 is a sheet of phosphor 66. Then, a bus bar 68, preferably made of copper or other conductive material is situated above the sheet of phosphor 66. Above the bus bar 68 is a clear conductive sheet 70, preferably made of a polyethylene and then finally on top is a sheet of urethane 72.

According to the teachings of the present invention, the laminated strip 12 is coated with a solvent free, stiff, fire retardant, aliphatic, water-borne urethane dispersion, namely a urethane polymer having a flame or fire retardant monomer and including tri-ethylamine, water, and a surfactant. More specifically the material is an aliphatic polyester with a halogen backbone and no co-solvent. Such a material is sold under the trademark HAUTHANE with specific non-changeable formulations. The preferred formulations are known as HD-2313 and HD-2314 and are manufactured and sold by C. L. Hauthaway & Sons of Lynn Mass. 01905. Preferably, two coats of HD-2313 or HD-2314 are applied to the components of the modular EL lamp strip kit or to the assembly made therefrom. HD-2313 is more flexible and may be preferred for some applications. The HAUTHANE brand HD series of fire retardant materials are preferred since they are clear or transparent.

Low add on levels of HD-2313 or HD-2314 enable synthetic materials to pass various FR tests including NFPA-701, MVSS-302, & others. The topcoat film properties of HD-2314 also provide stiff yet still flexible molding/pleating properties.

CHARACTERISTICS OF HD-2314:

Permanent, non-leaching fire retardancy.

Contains no co-solvent.

Excellent cost/performance ratio.

Stiff, tough, flexible, dry film.

High melting point (340° F.).

Excellent low temperature flex crack resistance.

Excellent abrasion resistance.

APPLICATION: The EL lamp strip 12 as well as the inverter and power supply unit 20 or 22 will have two applications each for maximum heat resistance. HD-2314 will be applied by either spray-on or topcoat methods until cured at 0.50 mil.

CURING: Excellent strength properties are supplied. Melamine-formaldehyde (3-6 phr) provides improved performance. Process of drying will be airborne for 24-36 hours and upon completion will meet all local and state code ASTM E84 standards.

| PHYSICAL PROPERTIES | TENSILE PROPERTIES |
|---|---|
| SOLIDS: 35.0%(+/−1%) | (Tested at 20 |
| | inches/minute) |
| VISCOSITY: 100-300 cps | ELONGATION: 245% |
| pH: 6.5-9.5 | ULT. TENS. STR. 3750 |
| | PSI |
| DENSITY: 8.9 lb/gal | 100% MODULUS: 2600 |
| | PSI |
| MELT POINT: 340 F. | 200% MODULUS: 3250 |
| | PSI |
| V.O.C. CONTENT: 1.3% | 300% MODULUS: NA |

The use of HD-2314 is an important feature of the EL lamp strip assemblies including the EL lamp strips 12 and the power unit 20, 22 or 122, since one important use of the EL lamp strip kit of the present invention is the provision of EL lamp strips 12, 28 and 30 that are highly fire resistant and highly water resistant so that the EL lamp strips can be used on a fireman's jacket or vest.

Additionally, such EL lamp strips find use on lifejackets where it is necessary to have water resistant or waterproof EL lamp strips 12 and on policeman's vests and construction worker's vests.

It is to be noted that some polycarbonates are clear and fire retardant. Other fire retardant materials that possibly could find use as coating materials on the strips and power units of the present invention are:

An aqueous based ceramic graphite coating sold under the trademark AVTEC by AVTECH Industries of Hudson Mass.

Antimony pentoxide in water combined with decabromodiphenyl oxide sold under the trademark NYACOL by Nyacol Nano Technologies, Inc. of Ashland Mass.

A polyester fiber composition sold under the trademark NOMEX by DuPont de Nemours of Wilmington Del.

A post-chlorinated polyvinyl chloride sold under the trademark TempRite by the B F Goodrich Company of Cleveland Ohio.

These materials are not clear and for that reason may not be preferred for some applications.

Referring now to FIGS. 13 and 13A, one preferred inverter and power supply unit 20 is shown. As shown in FIG. 13, which is an exploded view of the parts forming the power supply and inverter unit 20, there is first provided an elongate tubular lower body section 74 which receives several batteries such as two to four AA or AAA batteries. Then, received over the batteries in a threaded manner is a middle body section 76 having a tubular threaded end 78 with a sealing O-ring 80 situated thereon so that the junction between the middle body section 76 and the lower body section can be sealed when the middle body portion is threaded to the lower body section 76. The middle body section 76 mounts an ON/OFF switch 24 which, if desired, can be a three position switch, having, namely, an OFF position, an ON position, and an intermittent or blinking light position.

Also, mounted in the middle body section 76 is a conventional inverter circuit (hidden from view), the output of which is connected to a lower connector 82 that is adapted to connect with an upper connector 84 extending from an upper body section 86. The upper body section 86 has a length of cable 88 hermetically sealed to the upper body section 86 and extending from an upper end 90 of the upper body section 86.

The upper body section 86 has a lower, threaded tubular end 92 that has a sealing O-ring 94 thereon. This enables middle body section 76 to be threaded to the upper body section 86 with the O-ring 94 establishing a seal between the middle body section 76 and the upper body section 86 to form a water tight and waterproof inverter and power supply unit 20 as shown in FIG. 13A.

If desired, the body sections 74, 76 and 86 can be coated with HD-2314 which is highly fire retardant to enable the inverter and power supply unit 20 to be highly fire resistant as well as water resistant.

Also, according to the teachings of the present invention, in one embodiment a personal identification device (PID) having a transmitter for emitting a radio signal (which can be tracked by a global positioning system (GPS)) is mounted in the power unit 20 or 22. Such devices and systems can be obtained from Trimble Navigation Limited of Sunnyvale Calif. (See U.S. Pat. No. 6,094,164) or from Time Domain Corporation of Huntsville Ala. (See U.S. Pat. No. 6,300,903).

Still further, the power unit 20 or 22 can have a socket for a pin from a battery charger for recharging the batteries in the power unit 20 or 22. A rubber or plastic plug on a short strap secured to the power unit housing can be provided for sealing the socket and maintain the power unit waterproof.

In FIGS. 14A-C, is illustrated the lifejacket 40 on which five EL lamp strips 12 can be mounted, two on the front and three in the back, of the lifejacket 40. These EL lamp strips 12 can be interconnected by cables 42 and connectors 37 or 38 with the inverter and power supply unit 20 connected to one end of one of the EL lamp strips 12 on the front of the jacket as shown in FIG. 14A.

This kit typically will include five EL lamp strips 12, five wire cables 42 and the inverter and power supply unit 20. Such a kit can be sold through marine supply stores for use by sailors, particularly, sailors who are involved in night travel, e.g., motoring, sailing or racing.

In FIGS. 15A-15C, there is illustrated a safety vest 41, typically worn by a fireman or policeman, that includes three long EL lamp strips 12, two short EL lamp strips 28, two long and three short wire cables 42, and an inverter and power supply unit 20 or 22, not shown. It will be understood that the inverter and power supply unit 20 or 22 will be received in a pocket 102 on the inside of the vest 41, as shown in FIG. 15C.

If desired the power unit 20 or 22 can have a PID therein.

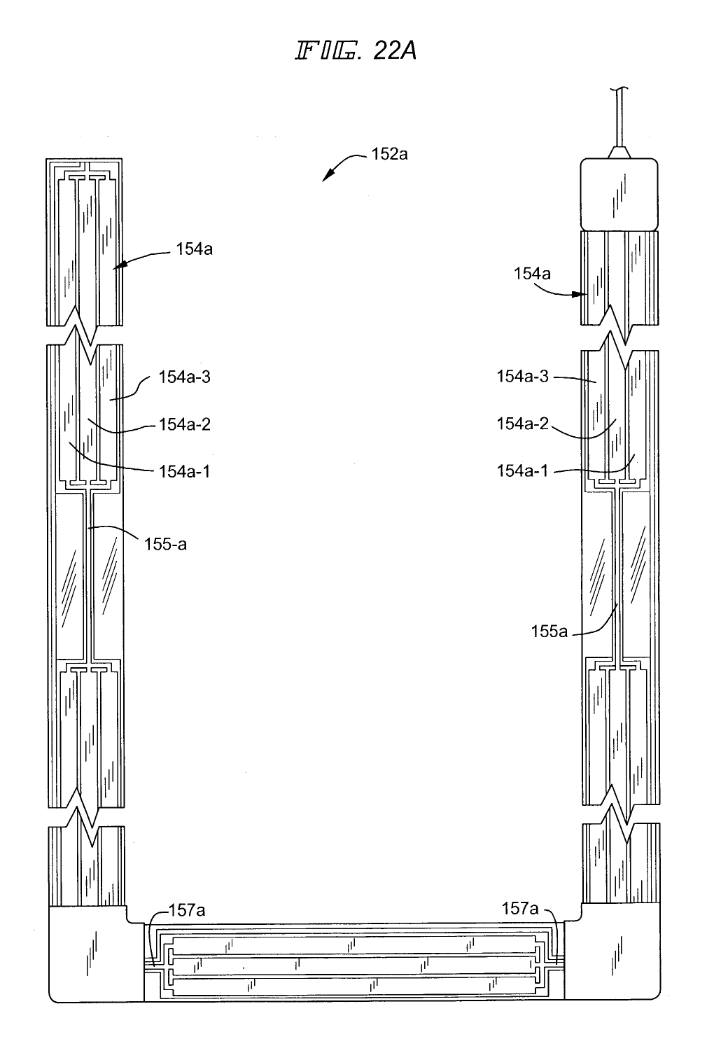

A simple kit is illustrated in FIGS. 16-19 and includes two elongate EL lamp strips 12, three wire cables 42, a three way connector 104, shown in FIG. 15, an EL wire and electrical cable assembly 105 and an inverter and power supply unit 106 shown in FIG. 17.

As shown in FIG. 16 each of the EL lamp strips 12 preferably has a cover sheet 34 over a bottom side thereof which can be removed to expose an adhesive 32 on the bottom side of each of the EL lamp strips 12. This enables the EL lamp strips 12 to be mounted wherever desired, for example, on the top of a helmet 112 as shown in FIG. 17 to form simulated illuminated horns. Such EL lamp strips 12 can also be mounted on either side of a bicycle frame member such as on the upper horizontal frame member extending between the seat and the front fork of a bicycle.

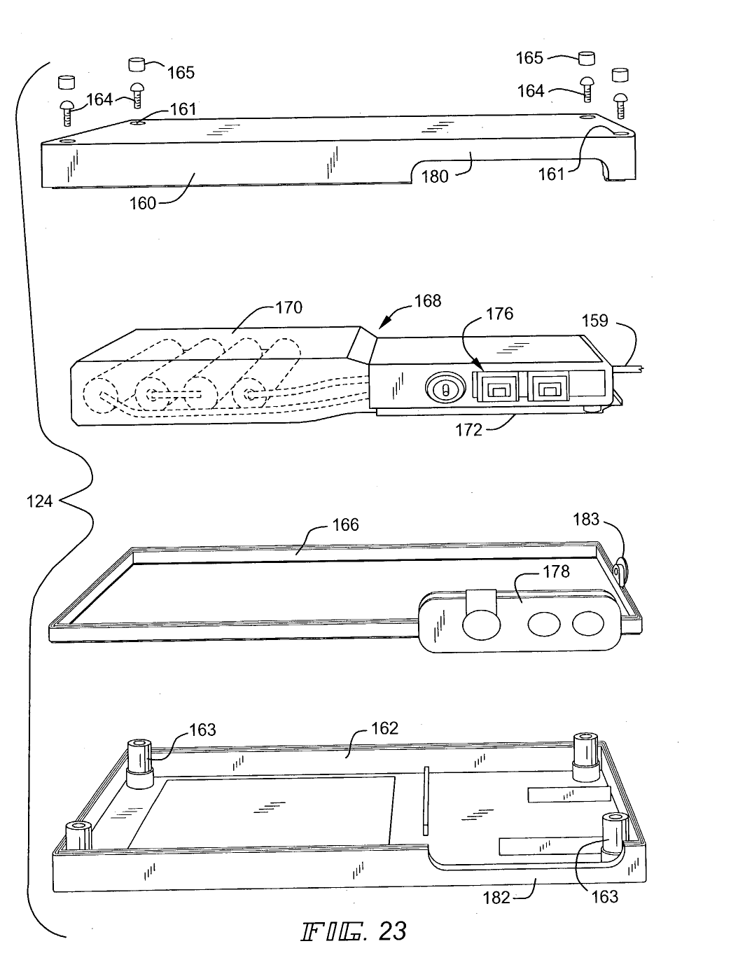

The EL wire and electrical cable assembly 105 (FIG. 19) includes a first prong connector 113, a section of an EL wire 114 (such as obtainable from Electroluminescent Industries of Jerusalem Israel), a sleeve 115, a wire cable 116 and a second prong connector 117 and extends from the three way connector 104 to the inverter and power supply unit 106.

The power supply unit 106 includes a box-shaped housing 118 having batteries and an inverter circuit therein and a flexible clip 119 secured to one side thereof. Preferably, a short strap 120 is held under the clip 119 and can be used to strap the power supply unit to a person's belt or to a bicycle tubular frame member. The power supply unit 106 can include rechargeable batteries or a rechargeable battery unit and a PID, if desired.

In its simplest form, the EL lamp strip kit of the present invention can include one EL lamp strip 12, one wire cable 121 with a waterproof coupling 122 and one inverter and power supply unit 124, or simply power unit 124, as shown in FIG. 20. This kit is suitable for mounting on an inner wall surface of a container, such as an ice chest. For this purpose, a back side 126 of the EL lamp strip 12 is coated with an adhesive which is covered by a peel-away cover sheet 128 and the power unit 124 has adhesive 130 on a back side 132 which is also covered by a peel-away cover sheet 134.

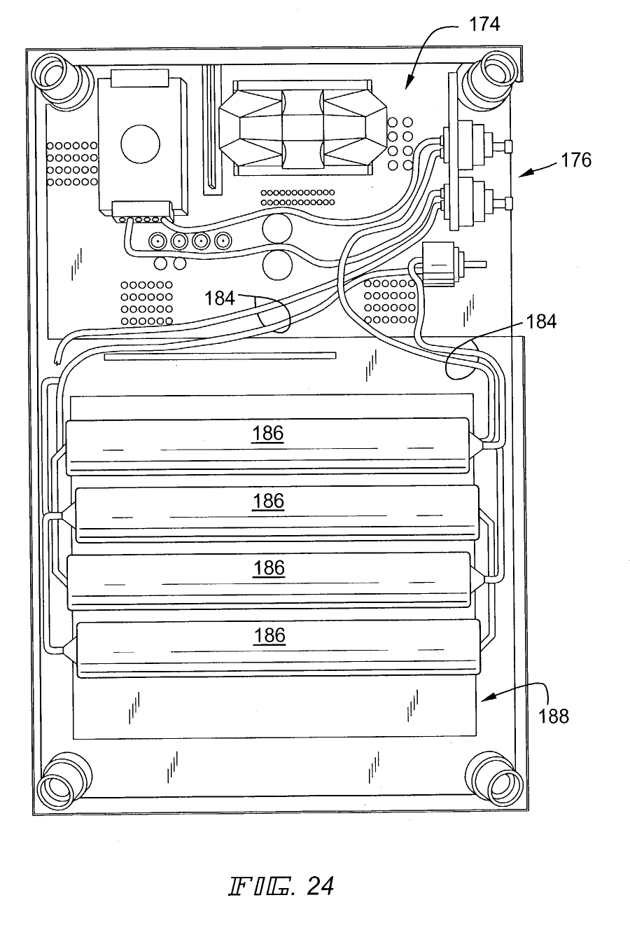

In FIG. 21 is shown a sectional view of the waterproof coupling 122. As shown the coupling 122 includes a male connector 136 mounted in a block 138 surrounded by a first rubber or synthetic boot 140 having a generally conical portion 141 and a generally cylindrical portion 142 with an inner annular groove 143 in the cylindrical portion 142. The conical portion 141 tapers to a sleeve portion that is fixed to and sealed on the wire cable 121.

The coupling 122 also includes a female connector (hidden from view) situated in a block 144. A latch 146 is provided on the block 144 and is adapted to latch with a keeper (not shown) on or in the block 138. A second rubber or synthetic boot 148 surrounds the block 144 and has a generally conical portion 149 and a generally cylindrical portion 150 with an outer annular bead 151. The boot 148 surrounds the block 144 and the bead 151 is adapted to mate with and seal with the annular groove 143 in the first boot 140 when the blocks 138 and 144 are brought together, latched and sealed. The conical portion 149 tapers to a sleeve portion that is fixed to and sealed on the cable 121.

FIG. 22 is a plan view of a pre-assembled U-shaped, EL lamp strip assembly 152 which includes 5 EL lamp strips 154 connected in series by two long flat wire cables 155, two corner connectors 156, two short flat wire cables 157 and an end terminal connector 158 connected together and waterproofed as one piece unit at the place of manufacture with a wire cable 159 extending therefrom for connection to a power unit 124 or 20. The U-shaped EL lamp assembly 152 is then combined with the waterproof coupling 122 and the waterproof power unit 124 or the waterproof unit 20. This pre-assembled U-shaped EL lamp strip assembly 152 is designed for mounting on a vest used by a fireman, policeman, member of the military, air ground personnel or construction worker. The U-shaped assembly 152 can have a urethane coating for waterproofing and can be simply glued onto a vest or can be mounted by other conventional means, e.g. sewed onto the vest. Preferably, the U-shaped, EL lamp strip assembly 152 including the wire cable 159, coupling 122 and power unit 124 are coated with HD-2313 or HD-2314 to make the EL lamp strip assembly 152 highly fire retardant. This EL lamp strip assembly 152 and coupling 122 and power unit 124 can be sold independently or in combination with a vest. Preferably at least one coat of urethane is applied to the U-shaped EL lamp strip assembly 152 and then two coats of HD-2314 is applied to the strip assembly 152, the coupling 122 and to the power unit 124 or 20.

In FIG. 22A is illustrated an EL lamp strip assembly 152a having EL lamp strip sections 154a which are interconnected by wire cables 155a and 157a and which each include three sections 154a-1, 154a-2 and 154a-3 which, preferably include a green strip, a red strip and a blue strip. This combination of colors is desirable for a strip assembly that is mounted on a fireman's vest or jacket, since different combustible materials emit different colored flames and it is easier to see a multi-colored, e.g., three colored, strip in a burning building. Of course, the colors of the sections 154a-1-3 can be any three colors desired. Note also that two or four strip sections can be provided instead of three.

As will be described in connection with FIG. 25, the wire cables 155 or 155a can include an easily dis-connectable plug and socket connector 200 (FIG. 25) so that a back panel mounting the short U-section including the wire cables 157 or 157a can be easily separated from the front panel mounting the leg sections of the EL lamp assembly 152 or 152a.

Referring now to FIG. 23, there is illustrated therein, an exploded view of the inverter and power supply unit 124 or simply power unit 124. As shown, the unit 124 comprises a housing which includes a generally rectangular upper housing shell 160 made of a hard, e.g., thermoplastic, material and having corner screw holes 161 and a generally rectangular lower housing shell 162 also made of a hard, e.g., thermoplastic, material. The lower shell 162 has four corner posts 163 in the shell 16 for receiving four screws 164. Four rubber plugs 165 are provided for sealing the screws 164 in the screw holes 161.

In between the housing shells 160 and 162, there is provided a generally rectangular gasket 166 that engages and seals against the opposed edges of the shells 160 and 162. Preferably the gasket 166 is also coated with a silicone gel to enhance waterproofing.

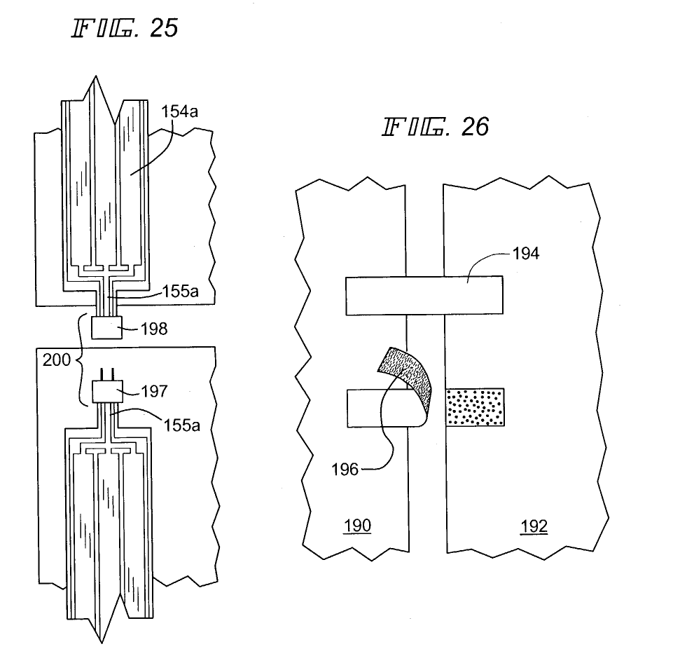

Located inside the housing is a partially, resin or epoxy, encapsulated combined inverter circuit board (FIG. 24) and battery receptacle 168. The battery receptacle portion is indicated by the reference numeral 170 and the encapsulated circuit board portion is indicated by the reference numeral 172. The inverter circuit board 174 (FIG. 24) is encapsulated as shown at 172 in FIG. 23 and has a switch assembly 176 on one side. The gasket 166 preferably includes a sealing pad or boot 178 that is received over the switch assembly 176 and is sealed to an outer side wall 180 of the housing upper shell 160 and to an outer side wall 182 of the housing lower shell 162 to waterproof the switch assembly 176. The switch assembly 176 can include an ON/OFF/INTERMITENT switch and a duty cycle adjust switch. Also, a rubber, friction fit grommet 183 is placed on the cable 159 to seal the entry opening of the cable 159 into the housing.

It will be understood that waterproofing is provided by the gasket 166, a gel placed thereon, the pad or boot 178, the grommet 183, the plugs 165 and by the encapsulating of the inverter circuit board 174. Also, if desired, waterproof connections of the battery leads 184 to the batteries 186 can be provided to further enhance the waterproofing of the power unit 124.

In FIG. 24, is shown, the inverter circuit board 174, the switch assembly 176, a battery receptacle 188, the battery leads 184 and the batteries 186. It is to be understood that the components shown in FIG. 24 are shown before being encapsulated.

If desired, the power supply unit 124 can include a PID on the circuit board 174 for enabling the power supply unit 124 to be tracked and/or a rechargeable battery system can be used which has an operating life of 4-8 hours and which can be easily replaced for recharging of the “battery low” battery unit. It is to be understood that the battery life or life of the power source is dependent on the supplier of the power source.

Often times the EL lamp strip assemblies are placed on vests or jackets used by fireman, policemen, security personnel or construction workers who are working in areas where moving objects or vehicles are nearby and it is possible that a front or back panel of a “placed over the shoulders” vest could be snagged or caught by the moving object causing the wearer to be pulled or dragged resulting in injury to the wearer. To prevent this from happening, a vest and EL lamp strip assembly on the vest are provided with breakaway front and back panels. As shown in FIGS. 25 and 26, this is accomplished by proving separate front and back panels 190 and 190 (FIG. 26) held together with hook and loop (VELCRO®) straps 194 and 196 which are located over each shoulder and perhaps, even between side edges of the panels 190 and 192 and by a plug 197 and socket 198 separable connector assembly 200 (FIG. 25) in each of the wire cables 155 or 155a of the EL lamp strip assembly 152 or 152a extending over each shoulder of the wearer. In this way, if one panel 190 or 192 is hooked, snagged or caught by a part of the moving object, the caught panel 190 or 192 easily will be pulled away from the other panel 192 or 190, without injury to the wearer.

From the foregoing description, it will be apparent that the modular EL lamp strip kit of the present invention has a number of advantages some of which have been described above and others of which are inherent in the invention. For example, kits can come in a variety of components the simplest being one EL lamp strip 12, one wire cable 42 and an inverter and power supply unit 20, 22, 106 or 124 as shown in FIG. 21. Also, as explained above, the kit can come with five elongate EL lamp strips and two-four wire cables 42 and one end terminator 36, two inline connectors 37, two corner connectors and one inverter and power supply unit 20, 22, 106 or 124 or whatever combination of components that is desired by a consumer. One popular kit assembly is the EL lamp assembly 152 or 152a which can be quickly mounted on a vest and provide electro-luminescent lighting with an assembly that is substantially waterproof and highly fire retardant. In some instances, the combination vest and EL lamp assembly 152 or 152a is sold as a single unit.

Still further, the EL lamp strips 12, 28 and 30 can be constructed to provide water resistance and fire retardant to the EL lamp strips and the inverter and power supply unit can be constructed to be substantially water resistant and/or fire retardant.

Moreover, the power supply units can include a PID for locating the wearer, rechargeable units can be provided having up to eight hours of charge, and the combination vests or jackets with EL lamp strip assemblies can be constructed with easily pull away front and back panels 190 and 192.

Additionally, the kits can be used on a variety of objects such as, for example, a helmet, a backpack, a lifejacket, a jacket and a safety vest, to name a few. Other uses will readily come to mind such as, for example, on a bicycle or in a container.

Also, it will be apparent that modifications can be made to the EL electro-luminescent lamp strip kits of the present invention and to the EL lamp strip assemblies that are constructed from a kit and placed on an object.

Accordingly, the scope of the EL lamp strip assembly kits and the EL lamp strip assemblies made therefrom and their combinations with objects, such as a vest, of the present invention are only to be limited by the accompanying claims.

I claim:

1. A modular kit of components for an electro-luminescent lamp assembly comprising:
at least one elongate electro-luminescent (EL) lamp strip having a front side which can emit electro-luminescent light and a back side having fixing means thereon for fixing said EL lamp strip to a surface;
an inverter and power supply unit including an inverter circuit and a battery power source;
said inverter and power supply unit having switch means including at least an ON position and an OFF position; and,
coupling means for coupling said EL lamp strip to said inverter and power supply unit after the EL lamp strip is mounted on an object.

2. The modular kit of claim 1 wherein said switch includes a third, blinking or flashing light position.

3. The modular kit of claim 1 wherein said inverter and power supply unit includes a duty cycle adjust switch.

4. The modular kit of claim 1 wherein said means for fixing each EL lamp strip to a surface includes an adhesive on said back side covered by a cover sheet until a user is ready to mount the EL lamp strips on a surface.

5. The modular kit of claim 1 wherein said means for fixing each EL lamp strip to a surface includes hook and loop material on said back side and mating hook and loop material fixable to a surface on the object where the EL lamp strip is to be mounted.

6. The modular kit of claim 1 wherein said inverter and power supply unit has means on a back side thereof for fixing the unit to a surface and includes an adhesive on said back side covered by a cover sheet until a user is ready to mount the unit on a surface.

7. The modular kit of claim 1 wherein said inverter and power supply unit has hook and loop material on a back side thereof for fixing the unit to a surface having mating hook and loop material fixed thereon.

8. The modular kit of claim 1 including a second EL lamp strip.

9. The modular kit of claim 1 wherein said EL lamp strip has a top layer and a bottom layer each made of water resistant material.

10. The modular kit of claim 1 wherein said EL lamp strip has a top layer or coating and a bottom layer or coating each made of a fire retardant material

11. The modular kit of claim 1 wherein said EL lamp strip has a top layer and a bottom layer each made of urethane.

12. The modular kit of claim 9 wherein said top layer and said bottom layer are coated with a highly fire retardant material.

13. The modular kit of claim 12 wherein said fire retardant material is an aliphatic polyester with a halogen backbone and no co-solvent and including tri-ethylamine, water, and a surfactant.

14. The modular kit of claim 8 combined with a helmet and wherein the EL lamp strips are fixed to the helmet much like horns and wherein said coupling means comprises at least one wire cable for connecting said EL lamp strips to the inverter and power supply unit.

15. The modular kit of claim 8 combined with a bicycle and wherein the EL lamp strips are fixed to the handle bars of a bicycle.

16. The modular kit of claim 8 combined with a bicycle and wherein said EL lamp strips are fixed to a frame member of the bicycle.

17. The modular kit of claim 8 further including a third EL lamp strip and said means for connecting said EL lamp strips to said inverter and power supply unit include at least three wire cables for inter-connecting said EL lamp strips and for connecting one EL lamp strip to said inverter and power supply unit.

18. The modular kit of claim 17 combined with a backpack and wherein one EL lamp strip is fixed generally horizontally on a back side of said backpack and the other two EL lamp strips are fixed, respectively to shoulder straps of the backpack.

19. The modular kit of claim 8 comprising at least three additional EL lamp strips, the EL lamp strips having end terminals, at least one end terminator for connecting end terminals of one EL lamp strip together, at least two inline connectors for connecting end terminals of one EL lamp strip to end terminals of another EL lamp strip, at least two corner connectors for connecting end terminals of an EL lamp strip to end terminals of another EL lamp strip which is positioned to extend transversely of said another EL lamp strip, and a wire cable for connecting one EL lamp strip to said inverter and power supply unit.

20. The modular kit of the claim 19 combined with a vest wherein a first one of said EL lamp strips with the end terminator at one end is fixed to and extends upwardly on a front side of the vest and is connected by one inline connector that extends over a shoulder portion of the vest to a second one of said EL lamp strips which is fixed to a back of the vest and extends to one of said corner connectors which is connected to a third one of said EL lamp strips that extends generally horizontally to the other corner connector from which a fourth one of said EL lamp strips fixed to the back of the vest extends generally upwardly to the other inline connector which extends over a shoulder portion of the vest to a fifth one of said EL lamp strips which is fixed to the front side of the vest and extends downwardly to the wire cable which connects with the inverter and power supply unit which is received in a pocket of the vest.

21. The modular kit and vest of claim 20 wherein said EL lamp strips are water resistant.

22. The modular kit and vest of claim 20 wherein said EL lamp strips are highly fire retardant.

23. The modular kit and vest of claim 22 wherein said EL lamp strips are coated with an aliphatic polyester with a halogen backbone and no co-solvent and including tri-ethylamine, water, and a surfactant to render the EL lamp strips highly fire retardant.

24. The modular kit and vest of claim 20 wherein said inverter and power supply unit is substantially waterproof.

25. The modular kit of claim 1 wherein said inverter and power supply unit comprises a waterproof housing including an elongate tubular lower body section for receiving batteries, a middle body section and a sealing O-ring situated thereon so that the junction between the middle body section and the lower body section is sealed when the middle body section is threaded to the lower body section, an ON/OFF switch, an inverter circuit and a first connector mounted to the middle body section, an upper body section having a second connector for connecting with said first connector and a lower, threaded tubular end for being threaded to said middle body section, an O-ring located between said middle body section and said upper body section and a cable hermetically sealed to the upper body section and extending from an upper end of said upper body section.

26. The modular kit of claim 25 wherein said housing is coated with a highly fire retardant material.

27. The modular kit of claim 26 wherein said housing is coated with an aliphatic polyester with a halogen backbone and no co-solvent and including tri-ethylamine, water, and a surfactant to render the EL lamp strips highly fire retardant.

28. The modular kit of claim 1 wherein said inverter and power supply unit includes a two piece waterproof housing comprising a generally rectangular upper housing shell made of a hard material and having corner screw holes and a generally rectangular lower housing shell made of a hard material and having four corner posts in the shell for receiving four screws, a generally rectangular gasket which engages and seals with opposed edges of the two shells and a grommet in an opening in the housing and over a wire cable where the wire cable enters the housing.

29. The modular kit of claim 28 including four rubber plugs for sealing screws in the screw holes.

30. The modular kit of claim 28 including a coating of silicone gel on the gasket.

31. The modular kit of claim 28 wherein said housing has mounted therein a partially, resin or epoxy, encapsulated combined inverter circuit board and battery receptacle and a switch assembly on one side of the circuit board.

32. The modular kit of claim 31 wherein said gasket includes a sealing pad or boot which is received over the switch assembly and is sealed to an outer side wall of the housing upper shell and to an outer side wall of the housing lower shell to waterproof the switch assembly.

33. The modular kit of claim 28 wherein said housing is coated with a highly fire retardant material.

34. The modular kit of claim 28 wherein said housing is coated with an aliphatic polyester with a halogen backbone and no co-solvent and including tri-ethylamine, water, and a surfactant to render the EL lamp strips highly fire retardant.

35. The modular kit of claim 1 wherein said EL lamp strips have at least two EL lamp strip sections to present at least two parallel EL lamp strip sections.

36. The modular kit of claim 35 wherein said EL lamp strip sections each have a different color.

37. The modular kit of claim 35 wherein three EL lamp strip sections are provided and have the colors green, red and blue.

38. The modular kit of claim 1 wherein the power supply unit includes a rechargeable battery system and a socket in a housing of the power supply unit for receiving a pin from a recharging system.

39. The modular kit of claim 38 wherein said power unit housing has a plug on a short strap secured to the power unit housing for sealing the socket to prevent entry of water.

40. The modular kit of claim 1 wherein said power supply unit has a personal identification device including a transmitter which can communicate with a receiver located at a distance from the transmitter.

41. The modular kit of claim 1 wherein wire cables are provided for connecting EL lamp strips on the front and the back of a vest on which the EL lamp strips are mounted and the wire cables extend over the wearer's shoulders and include an easily separable plug and socket connector and the vest has separable font and back panels releasably connected by pull-away straps.

42. The modular kit of claim 41 wherein said straps are releasably connected together by mating hook and loop fastening means.

43. A pre-assembled EL lamp strip assembly including 5 EL lamp strips connected in series with two corner connectors an end terminal connector as one unit at the place of manufacture and forming the shape of a U, a wire cable including a waterproof coupling coupled to the end terminal connector and a waterproof inverter and power supply unit coupled through said wire cable and waterproof coupling to said end terminal connector.

44. The EL lamp strip assembly of claim 43 wherein the components of the assembly are coated with a fire retardant material.

45. The EL lamp strip assembly of claim 44 wherein said fire retardant material is an aliphatic polyester with a halogen backbone and no co-solvent and including tri-ethylamine, water, and a surfactant.

46. The EL lamp strip assembly of claim 43 wherein said coupling comprises a male connector mounted in a first block surrounded by a first rubber or synthetic boot having a first generally conical portion and a first generally cylindrical portion; a female connector mounted in a second block surrounded by a second rubber or synthetic boot having a second generally conical portion and a second generally cylindrical portion with the second generally cylindrical portion being received in said first generally cylindrical portion when said male connector is connected with said female connector.

47. The EL lamp strip assembly of clam 43 wherein said second generally cylindrical portion has an outer annular bead and said first generally cylindrical portion has an inner annular groove, said bead being adapted to mate with and seal with the annular groove when the male and female connectors are brought together.

48. The EL lamp strip assembly of claim 43 including a latch on one block and a keeper on the other block, which engage each other and latch inside the boots when the connectors are brought together.

49. The EL lamp strip assembly of claim 43 wherein said inverter and power supply unit includes a two piece housing comprising a generally rectangular upper housing shell made of a hard material and having corner screw holes and a generally rectangular lower housing shell made of a hard material and having four corner posts in the shell for receiving four screws, a generally rectangular gasket which engages and seals with opposed edges of the two shells and a grommet in an opening in the housing and over a wire cable where the wire cable enters the housing.

50. The EL lamp strip assembly of claim 49 including four rubber plugs for sealing screws in the screw holes.

51. The EL lamp strip assembly of claim 49 including a coating of silicone gel on the gasket.

52. The EL lamp strip assembly of claim 49 wherein said housing has mounted therein a partially, resin or epoxy, encapsulated combined inverter circuit board and battery receptacle and a switch assembly on one side of the circuit board.

53. The EL lamp strip assembly of claim 49 wherein said gasket includes a sealing pad or boot which is received over the switch assembly and is sealed to an outer side wall of the housing upper shell and to an outer side wall of the housing lower shell to waterproof the switch assembly.

54. The EL lamp strip assembly of claim 43 wherein said EL lamp strips have at least two EL lamp strip sections to present at least two parallel EL lamp strip sections each having the same or a different color.

55. The EL lamp strip assembly of claim 54 wherein three EL lamp strip sections are provided and have the colors green, red and blue.

56. The EL lamp strip assembly of claim 43 wherein the power supply unit includes a rechargeable battery system and a socket in a housing of the power supply unit for receiving a pin from a recharging system.

57. The EL lamp strip assembly of claim 56 wherein said power unit housing has a plug on a short strap secured to the power unit housing sealing the socket to prevent entry of water.

58. The EL lamp strip assembly of claim 43 wherein said power supply unit has a personal identification device including a transmitter, which can communicate with a receiver, located at a distance from the transmitter.

59. The EL lamp strip assembly of claim 43 combined with a vest having a front panel and a rear panel.

60. The EL lamp strip assembly of claim 59 wherein wire cables are provided for connecting the EL lamp strips situated on the front and the back of a vest on which the EL lamp strips are mounted and the wire cables extend over the wearer's shoulders and include an easily separable plug and socket connector and said vest has separable front and back panels releasably connected by pull-away straps.

61. The EL lamp strip assembly of claim 60 wherein said straps are releasably connected together by mating hook and loop fastening means.
